(19) United States
(12) Patent Application Publication
(10) Pub. No.: US 2017/0271637 A1
(43) Pub. Date: Sep. 21, 2017

(54) METHOD OF MANUFACTURING POROUS POLYMER MEMBRANE USING WATER PRESSURE AND BATTERY SEPARATOR COMPRISING POROUS POLYMER MEMBRANE MANUFACTURED BY THE METHOD

(71) Applicant: Sangmyung University Seoul Industry Academy Cooperation Foundation, Seoul (KR)

(72) Inventors: Sang-Wook KANG, Seoul (KR); Woong-Gi LEE, Seoul (KR); Seok-Ju KANG, Ulsan (KR)

(21) Appl. No.: 15/405,972

(22) Filed: Jan. 13, 2017

(30) Foreign Application Priority Data
Mar. 16, 2016 (KR) 10-2016-0031247

(51) Int. Cl. H01M 2/14; C08J 9/26; C08J 5/22; B01J 39/22; H01M 2/16; C08J 9/00

(52) U.S. Cl. CPC H01M 2/145; H01M 2/166; C08J 9/0066; C08J 5/2212; B01J 39/22; C08J 9/26; C08J 2301/12; C08J 2201/0444; C08J 2205/044

(57) ABSTRACT

Disclosed is a method of manufacturing a porous polymer membrane, including forming pores by applying water pressure to a polymer membrane composed of a polymer and a metal salt, wherein the porous polymer membrane has properties suitable for use as a separator for a secondary battery.

### CROSS REFERENCE TO RELATED APPLICATION

This application claims priority to Korean Patent Application No. 10-2016-0031247, filed on Mar. 16, 2016, and all the benefits accruing therefrom under 35 U.S.C. §119, the content of which in its entirety is herein incorporated by reference.

### BACKGROUND OF THE INVENTION

1. Technical Field

The present invention relates to a method of manufacturing a porous polymer membrane and, more particularly, a porous polymer membrane, which has properties suitable for use as a separator for a secondary battery.

2. Description of the Related Art

A porous material, especially a membrane having nano-sized pores, is receiving attention these days in the fields of nano technology, biotechnology, and environmental technology due to various applications including gas storage, filtering, battery separation, water treatment, water purification, etc.

The porous polymer membrane of the invention has properties suitable for use in a separator of a secondary battery. A lithium secondary battery, which is a typical example of a secondary battery, is configured such that an anode, a cathode, and a porous separator disposed therebetween are assembled. The separator, which is interposed between the two electrodes of the battery, functions to prevent internal shorting due to direct contact between the cathode and the anode, and plays an important role as an ion path in the battery and in improving the safety of the battery. In particular, since lithium ions pass through the pores of the separator, the inner pore structure of the separator is regarded as very important.

When a porous polymer membrane is used as a separator for a battery, the inner structure thereof may be easily changed through the use of various polymer materials and functional materials. Hence, such a membrane is known to be a very good candidate for a separator for a lithium secondary battery.

A separator using a porous polymer membrane may be currently manufactured through various processes, such as thermally induced phase separation, phase inversion, track-etching, etc. However, these methods are problematic because the manufacturing process is complicated and expensive processing is required to achieve mass production. Due to such problems, the use of a porous polymer membrane as a battery separator is still difficult. With the goal of utilizing a porous polymer membrane as a battery separator, there is a need to develop a method of manufacturing a polymer membrane having nano-sized pores, which is simple, has low manufacturing costs and good energy efficiency, and is environmentally friendly.

With regard to patents related to porous polymer membranes, Korean Patent Application Publication No. 10-2014-0071094 discloses a method of manufacturing a porous polyolefin membrane, comprising the steps of extruding a polyolefin resin to form an extrusion film, annealing the extrusion film, and uniaxially drawing the extrusion film to form a porous membrane.

Also, Korean Patent No. 10-1536062 discloses a method of manufacturing a microporous polymer membrane, comprising the steps of extruding a resin composition to prepare a precursor film, annealing the precursor film, uniaxially drawing and then thermosetting the annealed film to form a microporous membrane, and photo-crosslinking the microporous membrane with UV light.

Also, Korean Patent Application Publication No. 10-2011-0026609 discloses a method of manufacturing a porous membrane, comprising the steps of kneading a resin mixture comprising 50 to 95 wt % of a polyolefin polymer, 5 to 50 wt % of a polyketone polymer, resulting from terpolymerization of carbon monoxide, unsaturated ethylene and propylene compounds, and the remainder of a plasticizer, melt-extruding the mixture to form a sheet, drawing the sheet in a longitudinal direction and a transverse direction to form a film, and extracting the plasticizer from the film and thermosetting the film.

Also, Korean Patent No. 10-1464430 discloses a method of manufacturing a microporous polymer membrane, comprising the steps of extruding a polymer compound or a composition including the same to form a precursor film, annealing the precursor film, low-temperature drawing the annealed film in a temperature range from a temperature −70° C. lower than the glass transition temperature of the polymer compound to a temperature +70° C. higher than the glass transition temperature of the polymer compound, high-temperature drawing the low-temperature-drawn film at an inclined angle of 20 to 65° in a temperature range from a temperature −40° C. lower than the melting temperature of the polymer compound to the melting temperature of the polymer compound, and alternately laminating two or more high-temperature-drawn films.

Conventional methods of forming pores in polymer membranes are mostly performed in a manner such that pores are formed through photoexposure or extraction of the plasticizer in the drawn polymer membrane, and thus the drawing process is required, the manufacturing processing is complicated, and it is very difficult to control the pore size and the porosity. Hence, in the case where a conventionally manufactured porous polymer membrane is used as a battery separator, the efficiency of the battery may be deteriorated.

### CITATION LIST

### Patent Literature

Korean Patent Application Publication No. 10-2014-0071094

Korean Patent No. 10-1536062

Korean Patent Application Publication No. 10-2011-0026609

Korean Patent No. 10-1464430

### SUMMARY OF THE INVENTION

Accordingly, the present invention has been made keeping in mind the problems encountered in the related art, and the present invention is intended to provide a novel method of forming fine pores, for example, nano-sized pores, in a polymer membrane.

In addition, the present invention is intended to provide a method of manufacturing a porous polymer membrane satisfying the properties necessary for a battery separator.

In addition, the present invention is intended to provide a method of manufacturing a porous polymer membrane, which obviates a drawing process, unlike conventional techniques, has a simple manufacturing process, and makes it possible to control a pore size and porosity.

The present invention provides a method of manufacturing a porous polymer membrane using water pressure, comprising: preparing a membrane from a mixed solution comprising a polymer, a metal salt and a solvent, and forming pores in the membrane by applying water pressure to the membrane.

The pore size and the porosity of the polymer membrane may be controlled depending on the magnitude of the water pressure.

The water pressure may range from 2 to 8 bar.

The porous polymer membrane may be formed on a porous support.

The polymer may include, but is not limited to, any one selected from poly(2-hydroxypropyl methacrylate), poly(2-ethyl-2-oxazoline), poly(acrylamide-co-acrylic acid), polymethacrylamide, polyacrylamide, poly(3-chloro-2-hydroxypropyl-2-methacryloxyethyldimethylammonium chloride), poly(acrylamide-co-2-methacryloxyethyltrimethylammonium bromide), poly(2-methacryloxyethyltrimethylammonium bromide), poly(2-vinyl-1-methylpyridinium bromide), poly(N-vinylpyrrolidone), poly(vinylamine hydrochloride), poly(l-lysine hydrobromide), poly(2-vinylpyridine), poly(4-vinylpyridine), poly(ethylene oxide-b-propylene oxide), poly(allylamine), poly(styrenesulfonic acid-co-maleic acid) sodium salt, poly(methacrylic acid), poly(ethylene-co-acrylic acid), poly(acrylic acid), poly(ethyl acrylate-co-acrylic acid), isotactic polypropylene, poly(vinyl methyl ether), poly(vinyl phosphoric acid) sodium salt, poly(styrenesulfonic acid), poly(N-vinyl acetamide), poly(N-vinyl acetamide-co-sodium acrylate), poly(N-methyl N-vinyl acetamide) homopolymer, poly(n-butyl acrylate-co-2-methacryloxyethyltrimethylammonium bromide), poly(vinylsulfonic acid), poly(N-vinylpyrrolidone-co-vinyl acetate), poly(styrenesulfonic acid-co-maleic acid), cellulose hydroxyethyl ether, cellulose methyl hydroxyethyl ether, poly(ethylene oxide), poly(vinyl acetate), poly(vinyl alcohol), poly(diallyldimethylammonium chloride), poly(maleic acid), poly(l-glycerol methacrylate), poly(butadiene-co-maleic acid), and poly(vinylphosphonic acid).

The metal salt may include, but is not limited to, any one selected from aluminum nitrate nonahydrate, ammonium cerium(IV) nitrate, ammonium nitrate, barium nitrate, beryllium nitrate, calcium nitrate hydrate, calcium nitrate tetrahydrate, cerium(III) nitrate hexahydrate, cesium nitrate, chromium(III) nitrate nonahydrate, cobalt(II) nitrate hexahydrate, copper(II) nitrate hemi(pentahydrate), iron(III) nitrate nonahydrate, lead(II) nitrate, lithium nitrate, lutetium(III) nitrate hydrate, magnesium nitrate hexahydrate, manganese(II) nitrate hydrate, mercury(I) nitrate dihydrate, mercury(II) nitrate monohydrate, mercury(II) nitrate solution, nickel(II) nitrate hexahydrate, palladium(II) nitrate dihydrate, palladium(II) nitrate hydrate, palladium(II) nitrate, potassium nitrate, ruthenium(III) nitrosyl nitrate, silver nitrate, sodium nitrate, titanium nitrate, zinc nitrate hexahydrate, nickel(II) chloride, nickel(II) chloride hexahydrate, nickel(II) acetate tetrahydrate, nickel sulfide, nickel(II) sulfate hexahydrate, nickel(II) nitrate hexahydrate, nickel boride, nickel(II) sulfate, nickel phosphide, nickel(II) acetylacetonate, nickel(II) perchlorate hexahydrate, nickel(II) bromide, nickel(II) hydroxide, nickel(II) bromide hydrate, nickel(II) phthalocyanine, nickel(II) trifluoromethanesulfonate, nickel(II) hexafluoroacetylacetonate hydrate, nickel(II) sulfate heptahydrate, ammonium nickel(II) sulfate hexahydrate, nickel carbonate basic hydrate, nickel(II) chloride hydrate, nickel(II) sulfamate tetrahydrate, nickel(II) carbonate hydroxide tetrahydrate, nickel(II) fluoride, Nickel(II) bromide trihydrate, nickel(II) oxalate dihydrate, nickel(II) octanoate hydrate, and nickel(II) cyclohexane butyrate.

The content ratio of the polymer to the metal salt may be set such that the metal salt is used in an amount of 0.01 to 0.6 mol relative to 1 mol of a polymer repeating unit.

In addition, the present invention provides a battery separator, comprising a porous polymer membrane manufactured by the above method.

According to the present invention, the pores in the polymer membrane can be formed by removing the metal salt therefrom or increasing the size of spaces in weakened portions of the polymer due to the plasticization effect of the metal salt through water-pressure treatment. The porous polymer membrane of the invention can be manufactured while controlling the pore size and porosity thereof in a comparatively simply manner such that a polymer membrane is formed using a solution process and is then subjected to water-pressure treatment.

In particular, the porous polymer membrane manufactured by the method of the present invention can be useful as a battery separator, thus achieving high battery efficiency, as can be confirmed experimentally.

### BRIEF DESCRIPTION OF THE DRAWINGS

The above and other features and advantages of the present invention will be more clearly understood from the following detailed description taken in conjunction with the accompanying drawings, in which:

FIG. 1A shows a scanning electron microscope (SEM) image of a membrane manufactured using cellulose acetate (CA) dissolved in pure acetone (hereinafter, referred to as “neat CA”);

FIG. 1B shows an SEM image of a membrane manufactured using CA dissolved in a mixed solvent of acetone/water (w/w 8:2);

FIG. 1C shows an SEM image of a membrane (without water-pressure treatment) manufactured using a mixed solution comprising a metal salt Ni(NO₃)₂.6H₂O, as well as CA dissolved in a mixed solvent of acetone/water (w/w 8:2);

FIG. 2 shows the results of measurement of the water flux of the neat CA membrane and the CA/Ni(NO₃)₂.6H₂O (1:0.23) membrane, depending on water pressure;

FIG. 3A shows the formation of pores by water pressure in the CA/Ni(NO₃)₂.6H₂O (1:0.23) membrane according to the present invention;

FIG. 3B shows an SEM image of the membrane after water-pressure treatment at 5 bar;

FIG. 3C shows an enlarged image of FIG. 3B;

FIG. 3D shows an SEM image of the cross-section of the membrane of FIG. 3B;

FIG. 3E shows an SEM image of the CA/Ni(NO₃)₂.6H₂O (1:0.23) membrane of the invention after water-pressure treatment at 8 bar;

FIG. 3F is an enlarged image of FIG. 3E;

FIG. 3G shows an SEM image of the cross-section of the membrane of FIG. 3E;

FIG. 4 shows the FT-IR spectrum of neat CA and the 1/0.23 Ni(NO₃)₂.6H₂O membrane after water-pressure treatment at 0 bar and 8 bar;

FIG. 5A shows the results of measurement of the porosity of the neat CA polymer membrane;

FIG. 5B shows the results of measurement of the porosity of the polymer membrane (without water-pressure treatment) manufactured using a solution comprising CA and a metal salt Ni(NO₃)₂.6H₂O at a weight ratio of 1:0.23;

FIGS. 5C, 5D and 5E show the results of measurement of the porosity of the membrane of FIG. 5B after water-pressure treatment at 2 bar, 5 bar and 8 bar, respectively;

FIG. 6 shows the results of thermogravimetric analysis (TGA) of the neat CA membrane, the CA/Ni(NO₃)₂.6H₂O (1:0.23) membrane (without water-pressure treatment), and the CA/Ni(NO₃)₂.6H₂O (1:0.23) membrane after water-pressure treatment at 8 bar;

FIG. 7A shows the structure of a lithium/CA separator/5 μm thick Li symmetric cell;

FIG. 7B shows the results of measuring the potential over time of the symmetric cells using the separator (black line) of Comparative Example, the separator (red line) after water-pressure treatment at 2 bar as the 1/0.23 CA/Ni(NO₃)₂.6H₂O separator, and the separator (blue line) after water-pressure treatment at 3 bar as the 1/0.23 CA/Ni(NO₃)₂.6H₂O separator;

FIG. 7C shows the structure of a lithium/CA separator/LTO half cell;

FIG. 7D shows the galvanostatic discharge-charge profile of the half cell using the 1/0.23 CA/Ni(NO₃)₂.6H₂O polymer separator after water-pressure treatment at 2 bar;

FIG. 7E shows the rate performance of the lithium/CA separator/LTO half cell; and

FIG. 8 shows the Nyquist plot in the Li/Ca separator/5 μm thick Li symmetric cells using the polymer separator of Comparative Example and the 1/0.23 CA/Ni(NO₃)₂.6H₂O polymer separator.

### DESCRIPTION OF SPECIFIC EMBODIMENTS

The present invention addresses a method of manufacturing a porous polymer membrane. The porous polymer membrane, manufactured by the method of the present invention, may be provided in any form, such as a flat type, a hollow fiber type, etc., and may be used alone or in combination with another structural element such as a support or the like. In particular, such a membrane is useful as a separator for a battery.

The present invention addresses a method of manufacturing a porous polymer membrane using water pressure, comprising the steps of preparing a membrane from a mixed solution of a polymer, a metal salt, and a solvent and forming pores in the membrane by applying water pressure to the membrane.

Below is a description of individual steps of the method.

Preparing Membrane

In the step of preparing the membrane, a mixed solution of a polymer, a metal salt, and a solvent is formed into a flat membrane or a hollow fiber membrane through a typical process. The mixed solution of a polymer, a metal salt, and a solvent is subjected to spin casting, knife casting or spinning, after which the solvent is removed through a drying process such as room-temperature drying, heat drying, or vacuum drying, thus enabling the formation of a solid membrane.

In the present invention, any kind of polymer may be used so long as it is typically formed into a film. Various polymers may be used in the present invention, as will be described in the following Test Examples. Thus, examples of the polymers are not limited within the scope of the present invention.

In the present invention, any metal salt may be used, and the kind of metal salt is not limited. Through the following Test Examples, various metal salts can be seen to be useful in the present invention. In the present invention, the metal salt may exhibit a plasticization effect within the polymer, and thus polymer chains in the membrane are made loose. While the metal salt escapes from the membrane due to the water pressure, pores are formed. Hence, the kind of metal salt is not particularly limited.

The porous polymer membrane of the present invention may be provided in the form of a film on a porous support, for example, a support having micro-sized pores, or alternatively may be provided as a film without a porous support.

Forming Pores

In the step of forming the pores, upon water-pressure treatment, the size of spaces in the polymer chains, which are weakened due to plasticization of the metal salt, is increased, and moreover, the metal salt escapes from the membrane, whereby pores may result.

In the present invention, the metal salt is solvated by the solvent component remaining in the polymer membrane, and may thus be formed into an ion aggregate larger than free ions or ion pairs. While such an ion aggregate is removed from the polymer membrane by means of the water pressure, pores having a uniform and linear shape are found to result. In the present invention, the term “water pressure” is used to have a meaning including not only water pressure using pure water, but also water pressure using an aqueous solution in which various chemical components are dissolved in water.

A better understanding of the present invention is given through the following Test Examples.

### Test Example 1: Measurement of Pore Size in Polymer Membrane Formed Using Various Solvents

Using an SEM, observed were pores of a membrane manufactured from CA (Cellulose Acetate) dissolved in pure acetone (“neat CA”), a membrane manufactured from CA dissolved in a mixed solvent of acetone/water (w/w 8:2), and a membrane (without water-pressure treatment) manufactured from a solution comprising a metal salt Ni(NO₃)₂.6H₂O and CA dissolved in a mixed solvent of acetone/water (w/w 8:2).

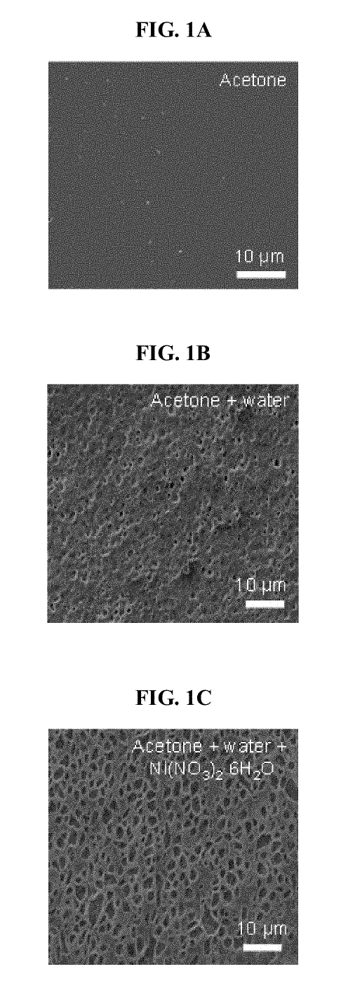

FIG. 1A shows an SEM image of the membrane (“neat CA”) obtained using CA dissolved in pure acetone. As shown in the SEM image of FIG. 1A, the membrane obtained from the CA polymer dissolved in pure acetone had no surface pores.

FIG. 1B shows an SEM image of the membrane obtained using CA dissolved in the mixed solvent of acetone/water (w/w 8:2). As shown in FIG. 1B, the membrane obtained from the CA solution in the mixed solvent of acetone/water had pores on the surface thereof. These pores have a diameter of about 1 μm, and are uniformly distributed on the surface of the polymer. This is due to the presence of water molecules having a high boiling point in the solution during the formation of the film. Although the pores are formed in the CA polymer matrix by the mixed solvent of acetone/water, controlling the pore size and porosity is still impossible in the course of manufacturing the membrane.

FIG. 1C shows an SEM image of the membrane (without water-pressure treatment) obtained through casting and drying of the mixed solution comprising the metal salt Ni(NO₃)₂.6H₂O, as well as the CA dissolved in the mixed solvent of acetone/water (w/w 8:2). As shown in FIG. 1C, the pore size and the porosity of the polymer matrix were drastically increased on the surface of the CA polymer. This is deemed to be due to the following two reasons. First, the solvated metal salt Ni(NO₃)₂.6H₂O may be aggregated in the polymer matrix during the solidification. As such, volatile acetone, used as the solvent, is rapidly volatilized, and thus the remaining Ni(NO₃)₂.6H₂O is aggregated to thereby form the pores in the CA polymer matrix. Second, strong molecular-level ionic bonding may occur between Ni, metal salt and water molecules. Such high interactions retard the evaporation of water molecules in the CA polymer matrix, whereby pores are formed on the surface of the polymer matrix. The CA including Ni(NO₃)₂.6H₂O functions to form pores in the matrix. When only the metal salt is added, the resulting pore size is unsuitable for use in a battery separator.

### Test Example 2: Formation of Pores Through Water-Pressure Treatment

A solution of CA/Ni(NO₃)₂.6H₂O at a weight ratio of 1:0.23 dissolved in a solvent (a mixed solvent of acetone/water, w/w 8:2) was cast and dried, thus manufacturing a membrane, which was then tested for its flux depending on isostatic water pressure. In Comparative Example, neat CA was tested, and the flux was measured using a mechanical flowmeter.

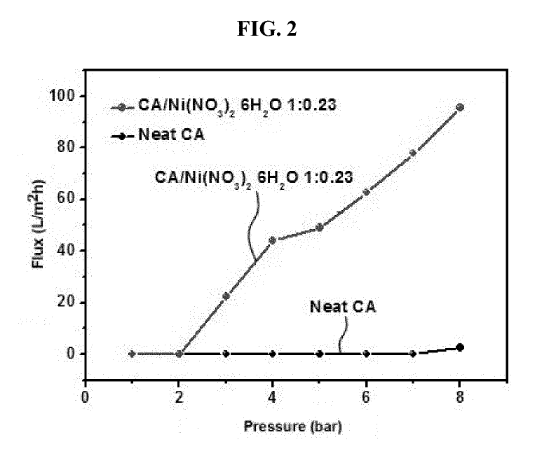

FIG. 2 shows the results of measurement of water flux depending on water pressure in the neat CA membrane and the CA/Ni(NO₃)₂.6H₂O (1:0.23) membrane. For the CA/Ni(NO₃)₂.6H₂O (1:0.23) membrane according to the present invention, the flux was almost zero until the water pressure was 2 bar, but was monotonically increased with an increase in water pressure under the condition that the water pressure was 3 bar or more.

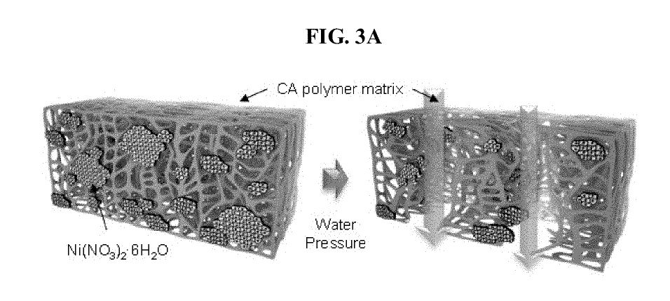

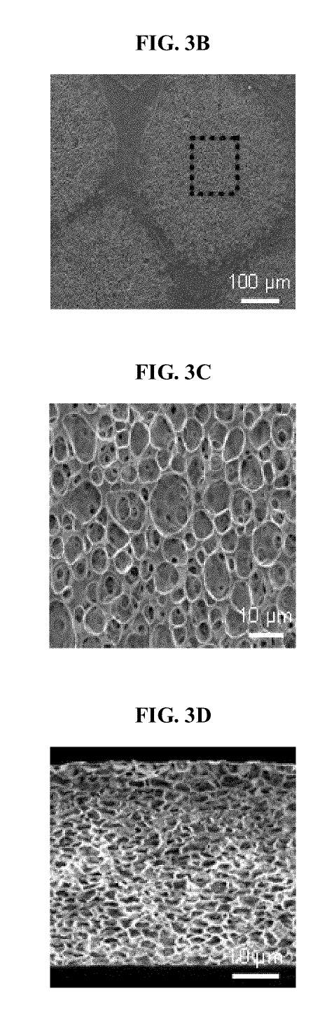

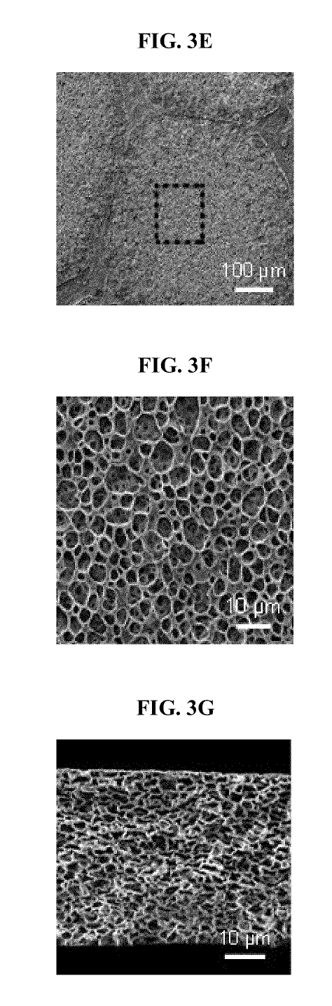

FIG. 3A shows the formation of pores by water pressure in the CA/Ni(NO₃)₂.6H₂O (1:0.23) membrane according to the present invention, FIG. 3B shows an SEM image of the membrane at a water pressure of 5 bar, FIG. 3C is an enlarged image of FIG. 3B, and FIG. 3D is an SEM image showing the cross-section of the membrane of FIG. 3B. FIG. 3E shows an SEM image of the membrane at a water pressure of 8 bar, FIG. 3F is an enlarged image of FIG. 3E, and FIG. 3G is an SEM image showing the cross-section of the membrane of FIG. 3E.

As shown in FIG. 3A, based on the results of testing of flux, water is passed through the weakened polymer chains by water pressure due to the presence of Ni(NO₃)₂.6H₂O in the CA matrix, and thus the flux is considered to be high when the water pressure is above the predetermined level.

With reference to FIGS. 3B to 3G, as seen in the SEM images of the pores formed when the 1:0.23 CA/Ni(NO₃)₂.6H₂O matrix was subjected to water-pressure treatment at 5 bar and 8 bar, the pore size and the porosity are observed to increase because interconnected pores are formed in the weakened polymer chains due to the plasticization effect of the metal salt Ni(NO₃)₂.6H₂O in the polymer membrane through water-pressure treatment.

### Test Example 3: FT-IR

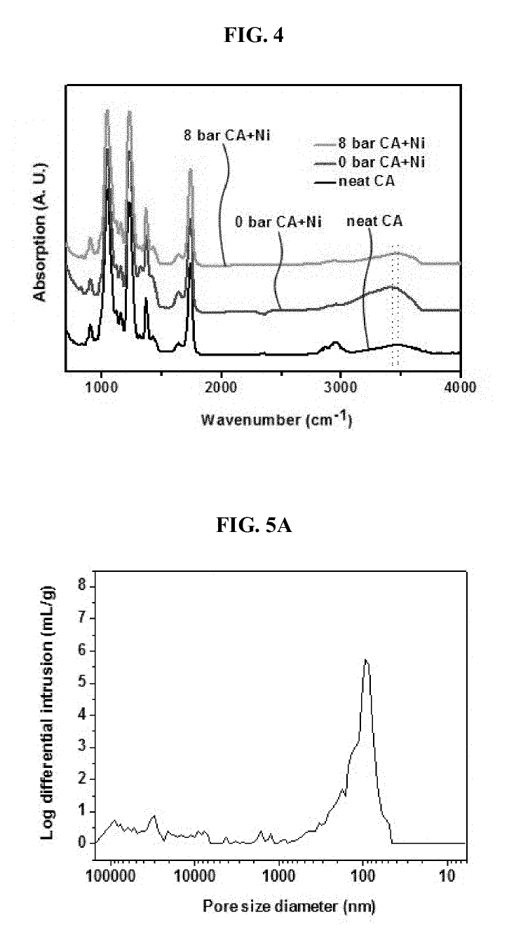

In order to understand the plasticization effect of the metal salt Ni(NO₃)₂.6H₂O in the CA chains during the water-pressure treatment, FT-IR was measured using a VERTEX 70 FT-IR spectrometer (Bruker Optics Inc.). FIG. 4 shows the FT-IR spectrum of the neat CA and the 1/0.23 Ni(NO₃)₂.6H₂O membrane subjected to water-pressure treatment at 0 bar and 8 bar.

The neat CA polymer matrix showed a characteristic IR peak at 3500 cm⁻¹, corresponding to the hydroxyl group of the CA polymer. On the other hand, the membrane including the metal salt Ni(NO₃)₂.6H₂O showed a representative absorption band for CA/Ni(NO₃)₂.6H₂O at 3400 cm⁻¹. This is because the large number of H₂O molecules in Ni(NO₃)₂.6H₂O increased the OH absorption peak intensity. When the CA polymer sample was treated at a water pressure of 8 bar, the 3400 cm⁻¹ peak of the CA/Ni(NO₃)₂.6H₂O was shifted to 3500 cm⁻¹, which means that a considerable amount of Ni(NO₃)₂.6H₂O escaped from the polymer matrix due to high water pressure.

### Test Example 4: Measurement of Porosity

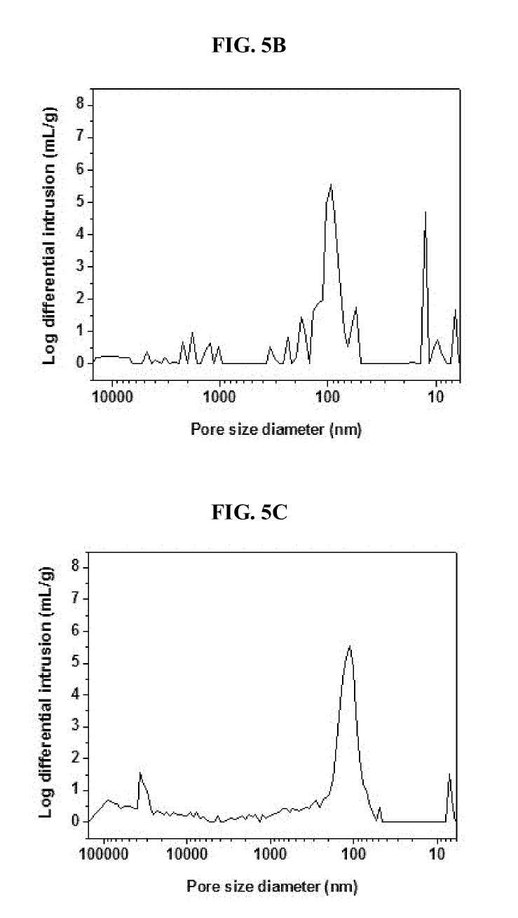

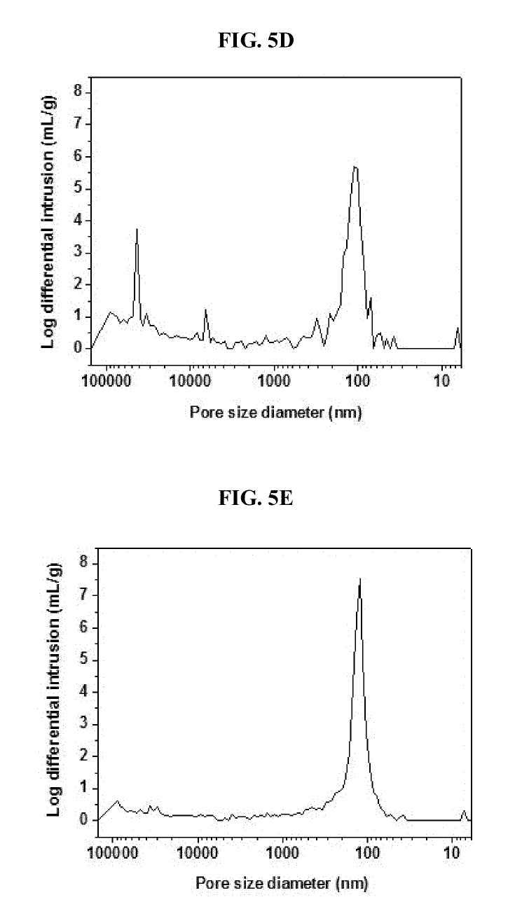

Another reason why the pore size and the porosity are increased in the CA polymer matrix was confirmed using a mercury porosimeter. FIG. 5A shows the results of measurement of the porosity of the polymer membrane obtained using the solution composed exclusively of CA dissolved in the solvent without the addition of the metal salt Ni(NO₃)₂.6H₂O, FIG. 5B shows the results of measurement of the porosity of the polymer membrane (without water-pressure treatment) obtained using the solution comprising the CA and the metal salt Ni(NO₃)₂.6H₂O at a weight ratio of 1:0.23, and FIGS. 5C, 5D and 5E show the results of measurement of the porosity of the polymer membrane of FIG. 5B after water-pressure treatment at 2 bar, 5 bar and 8 bar, respectively.

Referring to FIGS. 5A and 5B, a sharp peak appears at a pore size of 120 nm in the neat CA membrane. However, the CA polymer containing the Ni(NO₃)₂.6H₂O metal salt showed a wide band having a width of hundreds of nm, which means that the added metal salt functions to increase the pore size of the CA polymer matrix.

In order to evaluate changes in pores depending on the water-pressure treatment, water pressure was applied at 2 bar (FIG. 5C), 5 bar (FIG. 5D) and 8 bar (FIG. 5E). As shown in FIGS. 5C to 5E, in the polymer membrane samples including the metal salt Ni(NO₃)₂.6H₂O after water-pressure treatment, a large pore size and porosity were observed. Based on the measured data, when the metal salt was added to the polymer matrix, the pore size and the porosity were concluded to significantly increase due to water pressure.

### Test Example 5: Testing of Thermal Stability

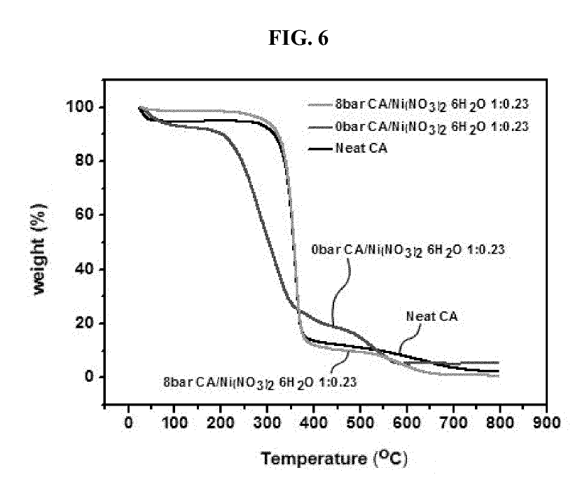

In order to evaluate the thermal stability of the porous polymer matrix of the present invention, TGA testing was performed. FIG. 6 shows the results of TGA of the neat CA membrane, the CA/Ni(NO₃)₂.6H₂O (1:0.23) membrane (without water-pressure treatment), and the CA/Ni(NO₃)₂.6H₂O (1:0.23) membrane after water-pressure treatment at 8 bar.

As for the neat CA membrane and the CA/Ni(NO₃)₂.6H₂O (1:0.23) membrane after water-pressure treatment at 8 bar, about 90 wt % thereof was decomposed at about 300° C. On the other hand, the CA/Ni(NO₃)₂.6H₂O membrane not subjected to water-pressure treatment was decomposed at 80% in the temperature range of 200 to 350° C., and the remaining 20% was decomposed in the range of 350 to 550° C. The boiling point of Ni(NO₃)₂.6H₂O is known to be 136.7° C. The reason why 80% of the CA/Ni(NO₃)₂.6H₂O membrane not subjected to water-pressure treatment was decomposed in the range of 200 to 350° C. is that Ni(NO₃)₂.6H₂O in the membrane was degraded and removed. However, the thermal stability of the membrane subjected to water-pressure treatment was increased compared to that of the CA/Ni(NO₃)₂.6H₂O membrane not subjected to water-pressure treatment. This is deemed to be because the CA/Ni(NO₃)₂.6H₂O was removed from the membrane through water-pressure treatment. Furthermore, the CA/Ni(NO₃)₂.6H₂O, which had remained in a small amount even after water-pressure treatment, was degraded and removed at about 400° C.

### Test Example 6: Application of Membrane of the Invention to Battery Separator

Battery-grade 1.3 M LiPF₆-EC/DEC having 10 wt % of an FEC electrolyte was used to constitute both a symmetric cell and a half cell. A 300 μm-thick sheet of pure Li metal and a 5 μm-thick sheet of Li metal on a piece of Cu foil were purchased from Wellcos. The cathode components comprising LTO, PVDF, and super P (8:1:1) were dissolved in NMP and then applied on a piece of Cu foil. The cathode was dried in a vacuum oven at 80° C. for 12 hr. A PS (Celgard 2400) separator was used for Comparative Example. The 2032 coin cells were used for symmetric-cell and half-cell measurement. The coin cells were pressurized using a crimping machine (Hohsen Corp). The battery cells were manufactured in an Ar-charged glove box (<0.1 ppm O₂ and H₂O).

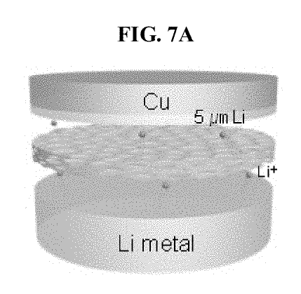

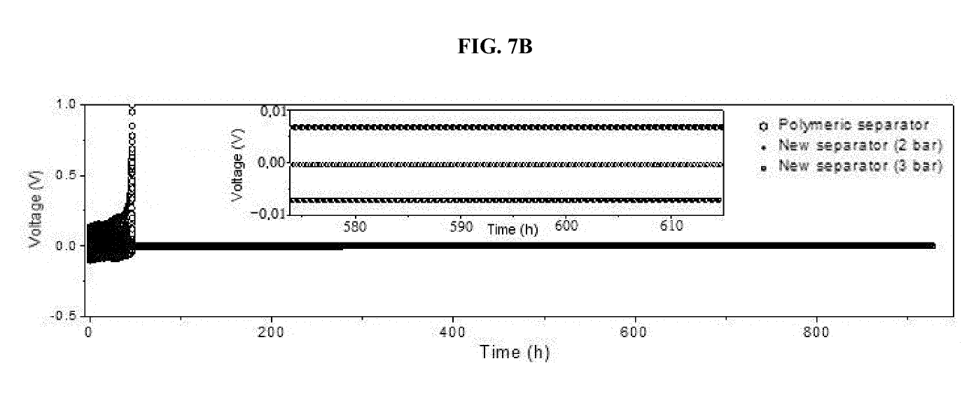

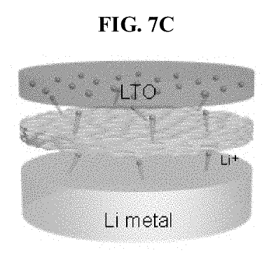

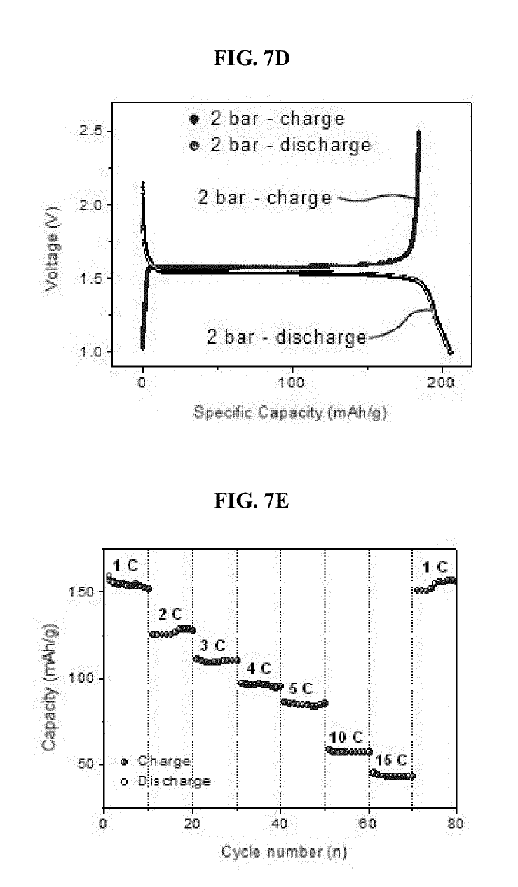

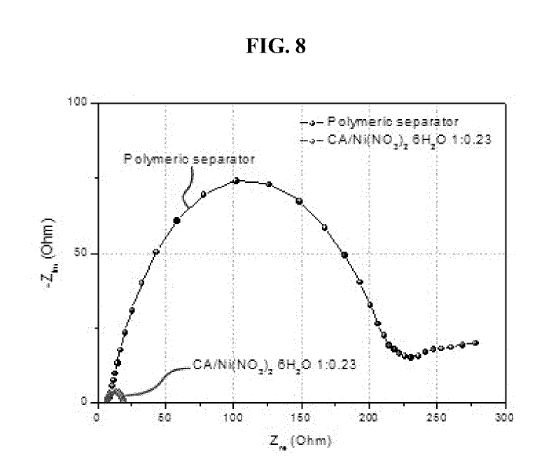

FIG. 7A shows the structure of a Li/CA separator/5 μm thick Li symmetric cell, and FIG. 7B shows the results of measurement of potential over time in the symmetric cells using the separator (black line) of Comparative Example, the 1/0.23 CA/Ni(NO₃)₂.6H₂O separator (red line) subjected to water-pressure treatment at 2 bar, and the 1/0.23 CA/Ni(NO₃)₂.6H₂O separator (blue line) subjected to water-pressure treatment at 3 bar. FIG. 7C shows the structure of a Li/CA separator/LTO half cell, FIG. 7D shows the galvanostatic discharge-charge profile of the half cell using the 1/0.23 CA/Ni(NO₃)₂.6H₂O polymer separator subjected to water-pressure treatment at 2 bar, and FIG. 7E shows the rate performance of the Li/CA separator/LTO half cell.

As shown in FIGS. 7A and 7B, the CA polymer separator manufactured by the method of the present invention was tested in the structure of Li metal/CA separator/5 μm thick Li on Cu foil through galvanostatic plating/stripping. The 1.3 M lithium hexafluorophosphate (LiPF₆) in ethylene carbonate (EC)/diethyl carbonate (DEC) (50 v/50 v) with a 10% fluoroethylene carbonate (FEC) additive was used as the electrolyte for the cell test. In order to measure the lithium cycling efficiency (LCE) of the separator of the invention, Li applied at a thickness of 5 μm on the Cu foil current collector was plated with 0.5 C of Li metal, and the 0.5 C of Li metal was stripped from the working electrode at a galvanostatic current ±0.5 mA. The cycling test was stopped by the potential cutoff of 1 V. This means that 5 μm thick Li on the Cu foil was depleted.

FIG. 7B shows the plating/stripping cycle potential profile of the polymer separator and the novel separator. As illustrated in this graph, the polymer separator of Comparative Example exhibited relatively high plating/stripping potential of ±0.15 V. On the other hand, the symmetric cell having the novel separator of the invention manifested showed plating/stripping potential of 0.06 V. In order to evaluate the increase in LCE, the polymer separator of Comparative Example and the novel separator of the invention were measured for impedance. As the result thereof, the impedance of the novel separator was decreased by 19 times compared to that of the polymer separator (FIG. 8), which is deemed to be because the cell resistance was decreased and the Li metal cycling was increased by virtue of the pore structure.

As shown in FIGS. 7C and 7D, in order to achieve real-world application of the separator of the present invention to batteries, a battery having the structure of LTO/separator of the invention/Li metal, with an electrolyte comprising 1.3 M LiPF₆ in EC/DEC (50 v/50 v) with 10% FEC, was manufactured. The galvanostatic discharge/charge profile exhibited stable discharging/charging plateau at 1.54 V and 1.58 V, respectively.

As shown in FIG. 7E, various current rates from 1 C to 15 C were measured using the half cell having the above structure. When the current rate of the cell was increased, the average capacity was monotonically decreased from 160 mAh/g to 50 mAh/g. When the current rate was reset to 1 C, the average capacity was restored to its original value. Here, “stable battery operation” means that the separator using the porous polymer membrane manufactured by the method of the present invention was able to maintain the Li ion exchange of the cell even at high current density.

### Test Example 7: Test of Flux of Polymer Membrane of the Present Invention Using Metal Salts Having Various Cations

Individual polymer membranes were manufactured by the method of the invention using a CA polymer and metal salts having various metal cations, the anions of which were fixed to nitric acid, and were then subjected to water-pressure treatment at water pressure ranging from 3 bar to 8 bar to form pores, followed by flux measurement. As such, the mass ratio of CA polymer to metal salt was 1:0.23. The results are shown in Table 1 below.

TABLE 1

| | 3 bar | 4 bar | 5 bar | 6 bar | 7 bar | 8 bar |
|---|---|---|---|---|---|---|
| Aluminum nitrate nonahydrate | 1.15 | 3.53 | 5.46 | 8.29 | 9.61 | 11.94 |
| Ammonium cerium(IV) | 5.13 | 6.84 | 8.52 | 10.62 | 11.49 | 12.02 |
| nitrate | | | | | | |
| Ammonium nitrate | 2.42 | 4.62 | 6.49 | 9.15 | 11.44 | 14.84 |
| Barium nitrate | 4.15 | 4.68 | 9.16 | 11.18 | 15.23 | 16.28 |
| Beryllium nitrate | 2.16 | 3.84 | 5.66 | 8.25 | 9.16 | 12.32 |
| Calcium nitrate hydrate | 3.18 | 5.23 | 6.28 | 7.16 | 8.19 | 11.62 |
| Calcium nitrate tetrahydrate | 5.29 | 8.46 | 11.62 | 14.63 | 17.62 | 20.18 |
| Cerium(III) nitrate | 4.16 | 6.94 | 8.18 | 10.84 | 12.63 | 16.95 |
| hexahydrate | | | | | | |
| Cesium nitrate | 2.02 | 4.12 | 6.84 | 10.62 | 12.52 | 15.32 |
| Chromium(III) nitrate | 2.08 | 3.51 | 8.27 | 10.68 | 13.95 | 15.66 |
| nonahydrate | | | | | | |
| Cobalt(II) nitrate hexahydrate | 5.16 | 10.23 | 14.65 | 15.84 | 16.32 | 18.22 |
| Copper(II) nitrate hemi(penta- | 3.04 | 4.95 | 7.26 | 9.55 | 14.23 | 16.84 |
| hydrate) | | | | | | |
| Iron(III) nitrate nonahydrate | 6.21 | 8.62 | 9.42 | 12.63 | 12.98 | 13.93 |
| Lead(II) nitrate | 3.16 | 4.84 | 5.62 | 6.75 | 8.26 | 9.32 |
| Lithium nitrate | 5.26 | 6.24 | 8.23 | 9.18 | 10.32 | 14.22 |
| Lutetium(III) nitrate hydrate | 2.64 | 4.32 | 5.16 | 6.28 | 7.18 | 8.92 |
| Magnesium nitrate | 8.16 | 9.24 | 11.05 | 12.01 | 13.75 | 14.6 |
| hexahydrate | | | | | | |
| Manganese(II) nitrate hydrate | 4.51 | 5.18 | 4.51 | 7.24 | 8.16 | 9.24 |
| Mercury(I) nitrate dehydrate | 2.16 | 3.84 | 4.85 | 6.94 | 8.64 | 9.95 |
| Mercury(II) nitrate | 5.15 | 6.84 | 8.24 | 9.72 | 11.32 | 14.25 |
| monohydrate | | | | | | |
| Mercury(II) nitrate solution | 4.16 | 5.85 | 7.84 | 9.14 | 10.69 | 12.84 |
| Nickel(II) nitrate hexahydrate | 5.62 | 6.84 | 7.96 | 8.15 | 9.55 | 10.82 |
| Palladium(II) nitrate dihydrate | 3.15 | 4.63 | 5.84 | 5.96 | 6.84 | 7.63 |
| Palladium(II) nitrate hydrate | 4.66 | 5.96 | 7.62 | 8.31 | 10.63 | 13.1 |
| Palladium(II) nitrate | 5.16 | 6.52 | 8.1 | 9.16 | 10.52 | 11.2 |
| Potassium nitrate | 8.15 | 10.63 | 14.21 | 15.95 | 17.2 | 19.03 |
| Ruthenium(III) nitrosyl nitrate | 6.23 | 6.95 | 7.24 | 7.68 | 8.95 | 9.15 |
| solution | | | | | | |
| Silver nitrate | 4.15 | 5.62 | 7.15 | 8.65 | 9.24 | 10.16 |
| Sodium nitrate | 8.16 | 9.18 | 10.62 | 11.85 | 12.63 | 14.62 |
| Titanium nitrate | 3.33 | 5.62 | 11.84 | 13.04 | 14.02 | 16.74 |
| Zinc nitrate hexahydrate | 2.26 | 4.18 | 4.51 | 7.16 | 8.94 | 11.34 |

As is apparent from the above results, the porous polymer membrane of the invention can be confirmed to be manufactured using all metal salts having various metal cations.

### Test Example 8: Test of Flux of Polymer Membrane of the Present Invention Using Metal Salts Having Various Anions

Individual polymer membranes were manufactured by the method of the invention using a CA polymer and metal salts having various anions, the metal cations of which were fixed to nickel, and were then subjected to water-pressure treatment at water pressure ranging from 3 bar to 8 bar, followed by flux measurement. As such, the mass ratio of CA polymer to metal salt was 1:0.23. The results are shown in Table 2 below.

TABLE 2

| | 3 bar | 4 bar | 5 bar | 6 bar | 7 bar | 8 bar |
|---|---|---|---|---|---|---|
| Nickel(II) chloride | 4.32 | 5.21 | 5.32 | 6.49 | 8.74 | 8.96 |
| Nickel(II) chloride | 2.61 | 4.13 | 5.16 | 6.25 | 9.32 | 10.16 |
| hexahydrate | | | | | | |
| Nickel(II) acetate tetrahydrate | 3.15 | 5.2 | 6.21 | 7.95 | 9.46 | 10.36 |
| Nickel sulfide | 0.95 | 1.35 | 2.42 | 3.16 | 5.24 | 6.12 |
| Nickel(II) sulfate hexahydrate | 2.62 | 3.84 | 5.31 | 5.96 | 6.95 | 8.94 |
| Nickel(II) nitrate hexahydrate | 2.11 | 2.95 | 4.38 | 5.28 | 6.19 | 10.32 |
| Nickel boride | 1.62 | 1.94 | 3.42 | 4.28 | 5.29 | 6.28 |
| Nickel(II) sulfate | 5.16 | 6.84 | 7.84 | 8.34 | 10.29 | 12.06 |
| Nickel phosphide | 2.42 | 4.63 | 5.32 | 6.49 | 8.24 | 8.94 |
| Nickel(II) acetylacetonate | 2.16 | 2.94 | 3.74 | 4.94 | 6.25 | 6.94 |
| Nickel(II) perchlorate | 5.24 | 6.84 | 7.61 | 8.21 | 10.32 | 12.03 |
| hexahydrate | | | | | | |
| Nickel(II) bromide | 0.94 | 2.1 | 3.49 | 4.18 | 5.16 | 6.84 |
| Nickel(II) hydroxide | 0.51 | 1.95 | 3.24 | 4.36 | 6.28 | 8.24 |
| Nickel(II) bromide hydrate | 2.34 | 4.13 | 5.34 | 6.95 | 8.46 | 9.22 |
| Nickel(II) phthalocyanine | 5.16 | 6.85 | 8.24 | 10.36 | 12.94 | 16.28 |
| Nickel(II) trifluoromethane- | 3.24 | 4.13 | 5.94 | 7.28 | 8.87 | 12.02 |
| sulfonate | | | | | | |
| Nickel(II) hexafluoroacetyl- | 1.23 | 2.04 | 3.24 | 4.84 | 5.16 | 6.15 |
| acetonate hydrate | | | | | | |
| Nickel(II) sulfate heptahydrate | 4.11 | 4.31 | 5.19 | 6.49 | 6.49 | 8.11 |
| Ammonium nickel(II) sulfate | 1.24 | 3.01 | 4.85 | 6.28 | 8.42 | 9.32 |
| hexahydrate | | | | | | |
| Nickel carbonate, basic | 2.12 | 4.16 | 6.38 | 8.54 | 9.25 | 10.21 |
| hydrate | | | | | | |
| Nickel(II) chloride hydrate | 1.32 | 3.84 | 6.49 | 7.49 | 8.94 | 10.11 |
| Nickel(II) sulfamate | 0.84 | 2.74 | 3.28 | 4.35 | 4.96 | 7.62 |
| tetrahydrate | | | | | | |
| Nickel(II) carbonate | 2.42 | 4.32 | 5.49 | 8.12 | 8.94 | 12.43 |
| hydroxide tetrahydrate | | | | | | |
| Nickel(II) fluoride | 1.94 | 2.38 | 5.49 | 6.28 | 8.43 | 8.32 |
| Nickel(II)) bromide trihydrate | 1.84 | 4.62 | 6.85 | 8.19 | 10.39 | 12.1 |
| Nickel(II) oxalate dihydrate | 2.31 | 5.17 | 6.94 | 7.29 | 8.29 | 9.42 |
| Nickel(II) octanoate hydrate | 1.02 | 2.94 | 3.74 | 4.61 | 6.49 | 8.94 |
| Nickel(II) cyclohexane | 1.32 | 3.32 | 4.65 | 5.86 | 6.94 | 10.26 |
| butyrate | | | | | | |

As is apparent from the above results, the porous polymer membrane of the invention can be confirmed to be manufactured using all metal salts having various anions.

### Test Example 9: Test of Flux of Polymer Membrane of the Present Invention Using Various Polymers

Individual polymer membranes were manufactured by the method of the invention using a nickel(II) nitrate hexahydrate as a metal salt and various polymers, and were then subjected to water-pressure treatment at water pressure ranging from 3 bar to 8 bar to form pores, followed by flux measurement. As such, the mass ratio of polymer to metal salt was 1:0.23. The results are shown in Table 3 below.

TABLE 3

| | 3 bar | 4 bar | 5 bar | 6 bar | 7 bar | 8 bar |
|---|---|---|---|---|---|---|
| Poly(2-hydroxypropyl | 1.21 | 1.95 | 3.62 | 5.26 | 6.84 | 8.16 |
| methacrylate) | | | | | | |
| Poly(2-ethyl-2-oxazoline) | 2.63 | 3.24 | 4.26 | 5.76 | 7.84 | 9.62 |
| Poly(acrylamide/acrylic acid) | 4.23 | 5.12 | 6.85 | 6.28 | 7.94 | 10.95 |
| Polymethacrylamide | 2.51 | 4.26 | 4.96 | 6.24 | 8.26 | 10.62 |
| Polyacrylamide | 3.63 | 5.24 | 6.42 | 6.43 | 8.42 | 10.93 |
| Poly(3-chloro-2-hydroxy- | 4.26 | 4.95 | 6.26 | 8.24 | 10.62 | 12.16 |
| propyl-2-methacryloxyethyl- | | | | | | |
| dimethylammonium chloride) | | | | | | |
| Poly(acrylamide/2- | 0.92 | 1.32 | 2.16 | 3.42 | 5.16 | 8.43 |
| methacryloxyethyltrimethyl- | | | | | | |
| ammonium bromide) | | | | | | |
| Poly(2-methacryloxyethyl- | 0.43 | 0.96 | 3.25 | 5.16 | 8.26 | 10.95 |
| trimethylammonium bromide) | | | | | | |
| Poly(2-vinyl-1-methyl- | 3.21 | 4.12 | 4.86 | 5.28 | 6.95 | 8.43 |
| pyridinium bromide) | | | | | | |
| Poly(N-vinylpyrrolidone) | 1.06 | 2.32 | 4.19 | 6.32 | 7.26 | 9.26 |
| Poly(vinylamine)- | 2.01 | 3.26 | 5.32 | 6.75 | 8.43 | 10.94 |
| hydrochloride) | | | | | | |
| Poly(1-lysine hydrobromide) | 2.13 | 4.85 | 6.72 | 7.29 | 10.95 | 13.43 |
| Poly(2-vinylpyridine) | 1.95 | 4.26 | 5.43 | 6.42 | 8.29 | 10.63 |
| Poly(4-vinylpyridine) | 2.01 | 3.94 | 6.72 | 7.26 | 9.41 | 10.94 |
| Poly(ethylene oxide-b- | 1.13 | 2.34 | 4.69 | 6.32 | 10.52 | 14.64 |
| propylene oxide) | | | | | | |
| Poly(allylamine) | 3.76 | 5.28 | 6.32 | 8.16 | 10.62 | 4.32 |
| Poly(styrenesulfonic acid/ | 1.08 | 3.26 | 4.21 | 6.28 | 8.94 | 10.42 |
| maleic acid) sodium salt | | | | | | |
| Poly(methacrylic acid) | 2.43 | 5.24 | 5.28 | 6.42 | 8.42 | 12.49 |
| Poly(ethylene/acrylic acid) | 2.53 | 6.13 | 6.34 | 8.25 | 10.34 | 13.84 |
| Poly(acrylic acid) | 4.13 | 5.29 | 8.31 | 8.94 | 12.29 | 14.43 |
| Poly(ethyl acrylate/acrylic | 2.34 | 4.21 | 5.43 | 6.29 | 8.22 | 10.31 |
| acid) | | | | | | |
| Isotactic Polypropylene | 5.16 | 6.76 | 8.43 | 10.42 | 12.49 | 13.14 |
| Poly(vinyl methyl ether) | 2.32 | 4.36 | 5.24 | 6.94 | 8.26 | 12.24 |
| Poly(vinyl phosphoric acid) | 0.84 | 2.43 | 5.16 | 6.29 | 8.9 | 10.94 |
| sodium salt | | | | | | |
| Poly(styrenesulfonic acid) | 1.24 | 3.85 | 5.24 | 6.59 | 9.29 | 11.75 |
| Poly(N-vinyl acetamide) | 2.84 | 5.43 | 6.03 | 8.43 | 12.1 | 14.43 |
| Poly(N-vinyl acetamide-co- | 2.31 | 4.26 | 6.72 | 9.26 | 11.62 | 13.3 |
| sodium acrylate) | | | | | | |
| Poly(N-methyl N-vinyl | 1.84 | 3.85 | 5.28 | 9.42 | 12.42 | 13.33 |
| acetamide) homopolymer | | | | | | |
| Poly(n-butyl acrylate/2- | 3.43 | 4.39 | 6.49 | 9.12 | 11.02 | 14.12 |
| methacryloxyethyltrimethyl- | | | | | | |
| ammonium bromide) | | | | | | |
| Poly(vinylsulfonic acid) | 2.05 | 2.64 | 5.16 | 6.29 | 8.62 | 10.95 |
| Poly(N-vinylpyrrolidone/vinyl | 2.31 | 4.62 | 6.32 | 8.24 | 9.42 | 11.43 |
| acetate) | | | | | | |
| Poly(styrenesulfonic acid/ | 1.82 | 4.26 | 5.94 | 8.26 | 11.16 | 14.26 |
| maleic acid) | | | | | | |
| Cellulose, hydroxyethyl ether | 4.32 | 5.43 | 6.42 | 10.42 | 11.95 | 15.62 |
| Cellulose, methyl | 0.84 | 2.32 | 4.28 | 6.95 | 8.94 | 13.42 |
| hydroxyethyl ether | | | | | | |
| Poly(ethylene oxide) | 0.62 | 4.12 | 6.14 | 8.42 | 9.64 | 11.52 |
| Poly(vinyl acetate) | 1.53 | 3.62 | 5.2 | 6.19 | 7.26 | 10.62 |
| Poly(vinyl alcohol) | 1.05 | 2.43 | 4.25 | 8.26 | 9.43 | 13.26 |
| Poly(diallyldimethyl- | 0.32 | 1.02 | 2.28 | 4.16 | 7.16 | 9.62 |
| ammonium chloride) | | | | | | |
| Poly(maleic acid) | 1.32 | 3.26 | 5.29 | 8.94 | 9.36 | 11.85 |
| Poly(1-glycerol methacrylate) | 2.15 | 3.26 | 5.21 | 6.29 | 8.15 | 10.95 |
| Poly(butadiene/maleic acid) | 2.95 | 4.21 | 6.29 | 8.24 | 9.23 | 10.43 |
| Poly(vinylphosphonic acid) | 4.32 | 5.75 | 5.29 | 8.26 | 10.94 | 12.02 |

As is apparent from the above results, the porous polymer membrane of the invention can be confirmed to be manufactured using various polymers.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of manufacturing a porous polymer membrane using water pressure, comprising:
preparing a membrane from a mixed solution comprising a polymer, a metal salt and a solvent; and
forming pores in the membrane by applying water pressure to the membrane.

2. The method of claim 1, wherein a pore size and a porosity of the polymer membrane are controlled depending on a magnitude of the water pressure.

3. The method of claim 1, wherein the water pressure ranges from 2 to 8 bar.

4. The method of claim 1, wherein the porous polymer membrane is manufactured on a porous support.

5. The method of claim 1, wherein the polymer comprises any one selected from poly(2-hydroxypropyl methacrylate), poly(2-ethyl-2-oxazoline), poly(acrylamide-co-acrylic acid), polymethacrylamide, polyacrylamide, poly(3-chloro-2-hydroxypropyl-2-methacryloxyethyldimethylammonium chloride), poly(acrylamide-co-2-methacryloxyethyltrimethylammonium bromide), poly(2-methacryloxyethyltrimethylammonium bromide), poly(2-vinyl-1-methylpyridinium bromide), poly(N-vinylpyrrolidone), poly(vinylamine hydrochloride), poly(l-lysine hydrobromide), poly(2-vinylpyridine), poly(4-vinylpyridine), poly(ethylene oxide-b-propylene oxide), poly(allylamine), poly(styrenesulfonic acid-co-maleic acid) sodium salt, poly(methacrylic acid), poly(ethylene-co-acrylic acid), poly(acrylic acid), poly(ethyl acrylate-co-acrylic acid), isotactic polypropylene, poly(vinyl methyl ether), poly(vinyl phosphoric acid) sodium salt, poly(styrenesulfonic acid), poly(N-vinyl acetamide), poly(N-vinyl acetamide-co-sodium acrylate), poly(N-methyl N-vinyl acetamide) homopolymer, poly(n-butyl acrylate-co-2-methacryloxyethyltrimethylammonium bromide), poly(vinylsulfonic acid), poly(N-vinylpyrrolidone-co-vinyl acetate), poly(styrenesulfonic acid-co-maleic acid), cellulose hydroxyethyl ether, cellulose methyl hydroxyethyl ether, poly(ethylene oxide), poly(vinyl acetate), poly(vinyl alcohol), poly(diallyldimethylammonium chloride), poly(maleic acid), poly(l-glycerol methacrylate), poly(butadiene-co-maleic acid), and poly(vinylphosphonic acid).

6. The method of claim 1, wherein the metal salt comprises any one selected from aluminum nitrate nonahydrate, ammonium cerium(IV) nitrate, ammonium nitrate, barium nitrate, beryllium nitrate, calcium nitrate hydrate, calcium nitrate tetrahydrate, cerium(III) nitrate hexahydrate, cesium nitrate, chromium(III) nitrate nonahydrate, cobalt(II) nitrate hexahydrate, copper(II) nitrate hemi(pentahydrate), iron(III) nitrate nonahydrate, lead(II) nitrate, lithium nitrate, lutetium(III) nitrate hydrate, magnesium nitrate hexahydrate, manganese(II) nitrate hydrate, mercury(I) nitrate dihydrate, mercury(II) nitrate monohydrate, mercury(II) nitrate solution, nickel(II) nitrate hexahydrate, palladium(II) nitrate dihydrate, palladium(II) nitrate hydrate, palladium(II) nitrate, potassium nitrate, ruthenium(III) nitrosyl nitrate, silver nitrate, sodium nitrate, titanium nitrate, zinc nitrate hexahydrate, nickel(II) chloride, nickel(II) chloride hexahydrate, nickel(II) acetate tetrahydrate, nickel sulfide, nickel(II) sulfate hexahydrate, nickel(II) nitrate hexahydrate, nickel boride, nickel(II) sulfate, nickel phosphide, nickel(II) acetylacetonate, nickel(II) perchlorate hexahydrate, nickel(II) bromide, nickel(II) hydroxide, nickel(II) bromide hydrate, nickel(II) phthalocyanine, nickel (II) trifluoromethanesulfonate, nickel(II) hexafluoroacetylacetonate hydrate, nickel(II) sulfate heptahydrate, ammonium nickel(II) sulfate hexahydrate, nickel carbonate basic hydrate, nickel(II) chloride hydrate, nickel(II) sulfamate tetrahydrate, nickel(II) carbonate hydroxide tetrahydrate, nickel(II) fluoride, nickel(II) bromide trihydrate, nickel(II) oxalate dihydrate, nickel(II) octanoate hydrate, and nickel(II) cyclohexane butyrate.

7. The method of claim 1, wherein a content ratio of the polymer to the metal salt is set such that the metal salt is used in an amount of 0.01 to 0.6 mol relative to 1 mol of a polymer repeating unit.

8. A battery separator, comprising a porous polymer membrane manufactured by the method of claim 1.

9. A battery separator, comprising a porous polymer membrane manufactured by the method of claim 2.

10. A battery separator, comprising a porous polymer membrane manufactured by the method of claim 3.

11. A battery separator, comprising a porous polymer membrane manufactured by the method of claim 4.

12. A battery separator, comprising a porous polymer membrane manufactured by the method of claim 5.

13. A battery separator, comprising a porous polymer membrane manufactured by the method of claim 6.

14. A battery separator, comprising a porous polymer membrane manufactured by the method of claim 7.
